(19) United States
(12) Patent Application Publication
(10) Pub. No.: US 2014/0194143 A1
(43) Pub. Date: Jul. 10, 2014

(54) METHOD AND A SYSTEM FOR THE LOCALISATION OF A COMMUNICATION DEVICE

(71) Applicant: Markus Krainz, Vienna (AT)

(72) Inventor: Markus Krainz, Vienna (AT)

(21) Appl. No.: 14/342,787

(22) PCT Filed: Sep. 8, 2012
(86) PCT No.: PCT/EP2012/067296

§ 371 Date: Mar. 5, 2014

(30) Foreign Application Priority Data
Sep. 8, 2011 (AT) A1287/2011

(51) Int. Cl. G01S 5/06

(52) U.S. Cl. CPC G01S 5/06
USPC 455/456.1

(57) ABSTRACT

The invention relates to a method for localising a communication device (1), wherein by measuring field strengths of a radio network (2) at known locations, an assignment is made of the field strength measured at the communication device (1) to the known locations, wherein the method comprises a calibration phase, a measuring phase, a post-processing phase, as well as a localisation phase; and an apparatus adapted to carry out the method for localising a communication device.

The invention relates to a method for the localisation of a communication device, wherein an assignment is made of field strengths measured on the communication device to a location by measuring field strengths of at least one radio network at known locations.

These days mobile communication devices in the form of mobile phones, smart phones, tablet PCs, laptops etc. are very common. Many of these devices are equipped with localisation devices, for example with a GPS receiver or an application which allows approximate locations to be derived from received radio networks.

Localisation devices or methods of this kind have, however, major disadvantages. For example, GPS receivers only work reliably in areas, where a fault-free reception of GPS signals is possible from several satellites. In urban areas in particular, this is not always guaranteed. In addition reception of GPS signals in interior spaces is not possible.

It is, however, just this localisation in interior spaces which is increasingly demanded by users. It would, for example, be extremely interesting to users in shopping centres, hospitals, airports or in other large buildings or roofed-over areas, if a reliable method were to be made available for localising or generating the shortest and quickest route between two points.

To this end prior art methods are known for localising a communication device, wherein an assignment is made of field strengths measured on the communication device to the location by measuring field strengths of at least one radio network at a known location.

For example the EP 1 731 919 B1 discloses such a method, wherein the radio network used is a WLAN network with several stations the locations of which are known. Due to initial measurements of field strengths on known or calculated locations it is possible to assign the received field strength to the locations in form of a data record. This assignment is fine-tuned further by dynamically determining further reference points.

Methods of this kind, however, have serious drawbacks. Firstly, it is not sufficient to carry out localisation merely on the basis of the signal strengths of WLAN networks. In many buildings WLAN networks are not available or too weak. Furthermore, the known methods are based on the assumption that all terminals used comprise an identical reception characteristic. This is, however, by no means the case: a network which is received by a first terminal with a certain signal strength, may have a substantially higher signal strength at another terminal in the same position.

Finally such a measuring procedure as known from the prior art may be distinctly expensive and long-winded and may generate a vast amount of data. Devices and methods for limiting the necessary amount of data are required in order to be able to implement the method on commercially available terminals and to ensure an acceptable runtime or response time.

It is therefore the object of the present invention to provide a method which eliminates the disadvantages of the prior art and permits a simple but accurate localisation of mobile communication devices in interior spaces. The method shall be independent of the respective radio network used and shall also be independent of the terminal used. Furthermore the method shall be able to be implemented in such a way that it can be implemented on as many terminals as possible without excessive hardware requirements. Furthermore the method shall be able to be quickly executed and not be limited to certain local conditions.

According to the invention this object is achieved in that a method for localising a communication device is proposed which comprises the following steps:
a calibration phase, in which for at least one radio network for an arbitrary number of communication devices and using a reference receiver, an assignment made of the reference field strength received by the reference receiver to the terminal field strength received by the respective communication device is recorded and stored;
a measuring phase in which for at least one radio network a field strength is recorded at known locations within the reception area, and processed and stored as a fingerprint preferably together with further data;
a post-processing phase, in which the data recorded in the calibration phase and the measuring phase are made available at least partially to the communication device preferably together with a map and further meta data;
a localisation phase, in which the field strength of at least one radio network is received at the communication device and in which the location of the communication device is at least approximately determined from the received terminal field strength and/or the data recorded during the calibration phase and the measuring phase.

The calibration phase permits to determine, for an arbitrary number of radio networks and an arbitrary number of terminals, an assignment specific to each terminal of the reference field strength received from a reference receiver to the terminal field strength received from the terminal. In the measuring phase the local conditions are checked through driving or walking, in order to obtain an unequivocal signal profile for each receivable radio network which can be provided within the range. It is unimportant with which receiver the measuring phase is performed: since in the calibration phase all assignments of the different receivers have already been recorded, measuring can be carried out with any given reference receiver or communication device provided.

According to the invention the radio network may be a broadcasting network, in particular VHF radio, a data network such as IEEE 802.11 (WLAN), a mobile communications network such as GSM or UMTS or another radio network such as CB radio, DCF77 or DECT, wherein suitable reference receivers may be provided for the reception of these radio networks.

In the calibration phase the reference receivers and the communication devices can measure the field strengths of the receivable radio networks simultaneously and at the same position, and record additional metadata such as frequency or channel or identifier of the radio network (BSSID for WLAN, BTS cell ID for GSM). It is, however, unimportant, whether the radio networks send an accompanying unequivocal identification themselves or whether identification is carried out based on the transmitting frequency or other characteristics as part of the method.

In addition the measuring characteristics of the reference receivers and/or the calibrated communication devices can be recorded during the calibration phase. This comprises, in particular for WLAN cards, specific information such as channel hopping or discretisation steps, but also statistic variables of the field strengths received such as mean value, variance or skewness of the relative frequency of occurrence. This data may be stored, according to the invention, for later processing and may be used in the localisation phase in order to give more specific details, for example, on the confidence interval of a measurement using a certain communication device.

Hidden networks that cannot be received in the localisation phase may be filtered out in the measuring phase or in the processing phase.

In the calibration phase the data recorded by the reference receivers and the communication devices may be transmitted to a data processing unit. Thereby the location can be changed repeatedly, until sufficient measured values are available for generating a communication device-specific and radio network-specific regression curve between the terminal field strengths recorded by the respective communication devices and the reference field strengths recorded by the reference receivers. The receiving situation may also be influenced in other ways, for example by an artificial improvement or deterioration of the radio reception in a stationery position, so that it is not necessary to move the receivers. The number of data points is of importance to the preparation of an accurate regression curve, but the method is not limited to a certain number of data points. For example, just two data points may be sufficient for estimating the offset between the reference receiver and the communication device.

In the calibration phase these communication device-specific and radio network-specific regression curves and/or the above-mentioned statistic parameters for at least one communication device used and at least one radio network received may be stored in an offset file. This offset file may be any given computer-readable file, such as a CSV, XML, or XLS file. The values, of course, may also be stored in a database in order to ensure quick access. Furthermore, according to the invention, provision may be made for storing, not the measured value as such, but only the parameters of a representation characterising the regression curve, in order to save storage space and to increase the speed of accessing the same.

During the calibration phase several reference receivers may be used for at least one radio network. In this case in particular, an averaging procedure may be used in order to reduce fluctuations in the signal field strength. Averaging over time may also be employed. For radio networks transmitting via several channels, the field strength received may be averaged across two or more of the transmitted channels.

Several reference receivers may be provided for WLAN reception, which, for example, in turn scan the existing channels by using channel hopping. In this way each channel (for example one of the 14 WLAN channels transmitted in the 2.4 GHz band) may be averaged across several reference receivers.

During the measuring phase, for radio networks transmitting on several channels, all or some of these channels may be captured simultaneously using reference receivers with several receiving modules. During the measuring phase also, averaging may be carried out across the received channels, in order to obtain a more robust measuring result. During the measuring phase, according to the invention, information may be recorded on the received radio networks, such as data on the transmitting intervals in the case of WLAN networks. It could be provided, for example, to record latency times or data on energy-saving modes of the radio transmitters (for example, if and when transmitting output is throttled). It is irrelevant whether the measuring phase is carried out using a reference receiver or a communication device, since the assignment of the received field strengths has already been recorded in the calibration phase.

During the measuring phase the field strength, RSS, the ID and/or the frequency of the radio network, the mean value, the variance and/or other statistic parameters of the reference field strength and the locations may be stored in a file, preferably in a CSV or XML file or in a database, preferably SQLite, optionally specifying the respective building storey. This data recorded during the measuring phase is called fingerprints.

The location may be stored in the form of absolute or relative location coordinates, position keys, room numbers, or any other unequivocal location identifiers.

During the measuring phase the direction of movement may be additionally recorded according to the invention. The device's own compass and/or a gyroscope or acceleration sensor may used for this purpose. In addition, if measurements are performed manually, signal attenuation (typically in the range of 6 dB) caused by the human body may be compensated for or a compensation factor may be recorded. An existing representation of the geographic conditions, such as a map, may be used. The measuring results may be superimposed on this map. During the measuring phase the reference field strength may be recorded at fixed local intervals, for example in the form of a chessboard pattern, at certain anchor points or along a previously defined path.

During the measuring phase the reference field strength may be recorded using a reference receiver connected with a computer or a communication device. The reference receiver may also be built into the communication device. Also during the measuring phase the geographic conditions may be recorded in the form of coordinates of walls, doors, rooms, corners, room identifiers and the like. Thus, according to the invention, it is possible to create a map of the local conditions or to adjust an existing map.

In particular, according to the invention, the conditions affecting the possibilities of movement may be recorded during the measuring phase. This includes, in particular, conveyor belts, such as used at airports, elevators or escalators. This information may also be stored in the database and utilised in the localisation phase for calculating probability values of the fingerprints. For example, a conveyor belt may have the effect of causing an increase in speed of the persons it carries, with the result that in the localisation phase more distant fingerprints relating to persons on the belt are given a higher weighting than fingerprints relating to persons not on the conveyor belt. The escalator has an effect upon the change of storey, wherein it is possible to record the direction in which the escalator moves and to determine therefrom the sole possible storey change during the localisation phase.

During the post-processing phase the measured data is made available to the terminals. This may comprise data from the calibration phase, preferably in the form of an offset file, data from the measuring phase, preferably in the form of an XML file or a database, as well optionally maps and metadata such as building names, the overall size of the area, storey names, room description, GPS coordinates of the origin and/or reference cell IDs.

During the subsequent localisation phase the positions ascertained by approximation may be illustrated, in particular be superimposed, on a representation, preferably a map, of the area covered and be communicated to the communication device.

Initial checks may be performed to ascertain which radio networks are receivable, followed by loading relevant fingerprints from the measuring phase into a memory of the communication device and adapting them to the currently used communication device or the currently used antenna.

During the localisation phase provision may be made according to the invention for loading only relevant fingerprints into a memory of the communication device. To this end clustering of fingerprints may be performed during the measuring phase, wherein a specified quality criterion is used and in particular outliers are removed. During the localisation phase typical fingerprints can then be loaded for each cluster according to the invention and compared with the received signals in order to determine in which cluster the user is situated. This has the advantage of having to store only a comparatively small number of fingerprints in the memory. When changing to an adjacent cluster the fingerprints of the new cluster may be loaded into the memory and the fingerprints of the old cluster may be dropped, at least partially.

In order to assess the relevance of fingerprints a probability estimate may be performed which takes local conditions into account. Using this probability estimate fingerprints may be given a weighting. Using the ascertained locations (such as coordinates) of the communication device and the input of the desired target further methods for finding a route (routing) may be carried out.

During the localisation phase, the direction of movement may be additionally detected according to the invention. The device's own compass and/or a gyroscope or an acceleration sensor may used for this purpose. In addition, signal attenuation caused by the human body may be taken into account in respect of the recorded signal strengths. If signal attenuation was also recorded during the measuring phase, then this has the advantage that the two correction factors cancel each other out for the same orientation.

During the localisation phase a compass and/or a gyroscope may be used in order to detect, in addition to the history of the previous positions, the current direction of movement and thus to contribute to the weighting of the probabilities of relevant fingerprints. Compass and/or gyroscope data may also be used to determine the probability of the communication device being located at a specific location. This data can be used to determine a confidence interval.

During the calibration, measuring and/or localisation phases the data packets received during reception of WLAN networks may be stored continually in a data buffer, in particular in a ring buffer which for example during the measuring phase has a size of 2 seconds and during the localisation phase a size of 5 seconds. This has the advantage of being able to fall back on the data stored in the buffer when retrieving measured data, thus accelerating the process.

Also during reception of WLAN radio networks provision may be made according to the invention for packets to be discarded which are received on a channel other than the specified transmitting channel. It can be provided that in the measuring phase, the magnetic field strength, its rate of change, the light intensity in the environment in connection with the time of day or date of week, or other particularly physical measuring values and their rates of change, are recorded and stored together with the fingerprints. By querying an accelerometer of the communication device, the magnetic field strength, or other measuring values, can be stored as a three-dimensional vector. In the localisation phase, these measured data can be used for calibration of the radio receiver and/or for the determination of the spatial coordinates, particularly if the received radio strength is small or no radio network can be received. Such a magnetic field vector (and its rate of change) can be used in particular to help determine the direction of movement in case the communication device is moved.

The communication device may store and/or feed back information about the received radio networks, received in the localisation phase, to a remote server for further processing.

The invention also relates to a device for the localisation of a communication device, wherein, by measuring field strengths of a radio network at known locations, an assignment is made of field strengths measured on the communication device to the locations, wherein the device is adapted to carry out any of the above described localisation methods.

The communication device may be a mobile phone, a smart phone, a notebook, a laptop, a tablet PC or any other portable electronic communication device. The device may be, in particular, a data processing unit which, in order to implement the method according to the invention, is connectable with at least one communication device and with at least one reference receiver.

The assignment of the reference field strength received from the reference receiver to the respective communication device may be stored in an offset file on a server. The recorded fingerprints may preferably be stored together with further data in an XML file or a database on a server.

Furthermore the invention comprises a computer program product for a system according to the invention, which is operable by a method according to the invention as well as a data carrier with a computer program product according to the invention. Further features according to the invention are to be found in the description of the embodiments, the claims and the figures.

The invention will now be described by way of typical embodiments, in which

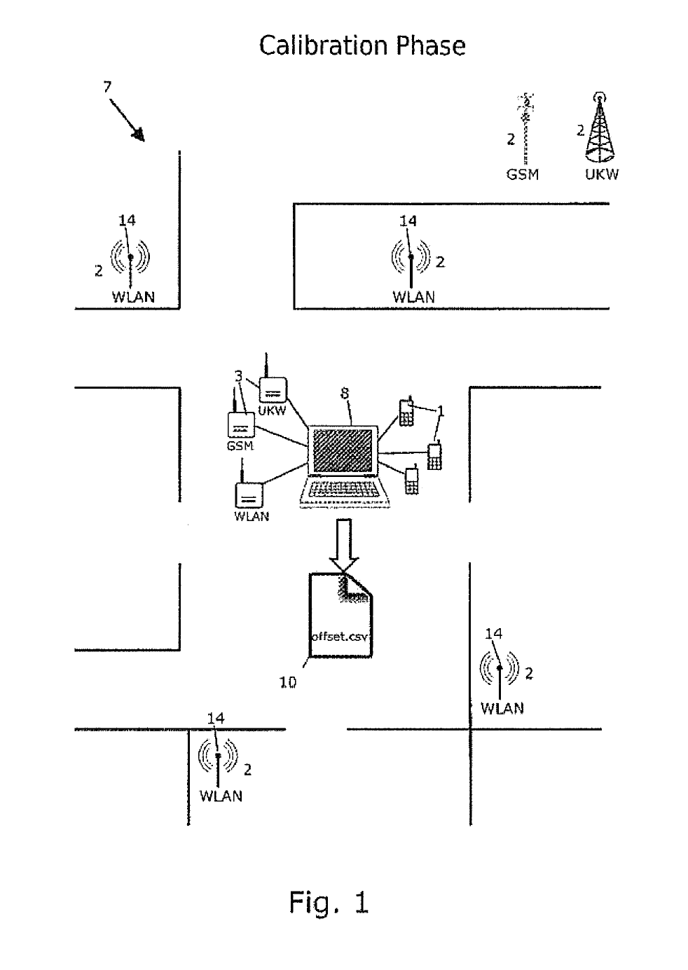

FIG. 1 shows a schematic representation of a typical embodiment of the calibration phase according to the invention;

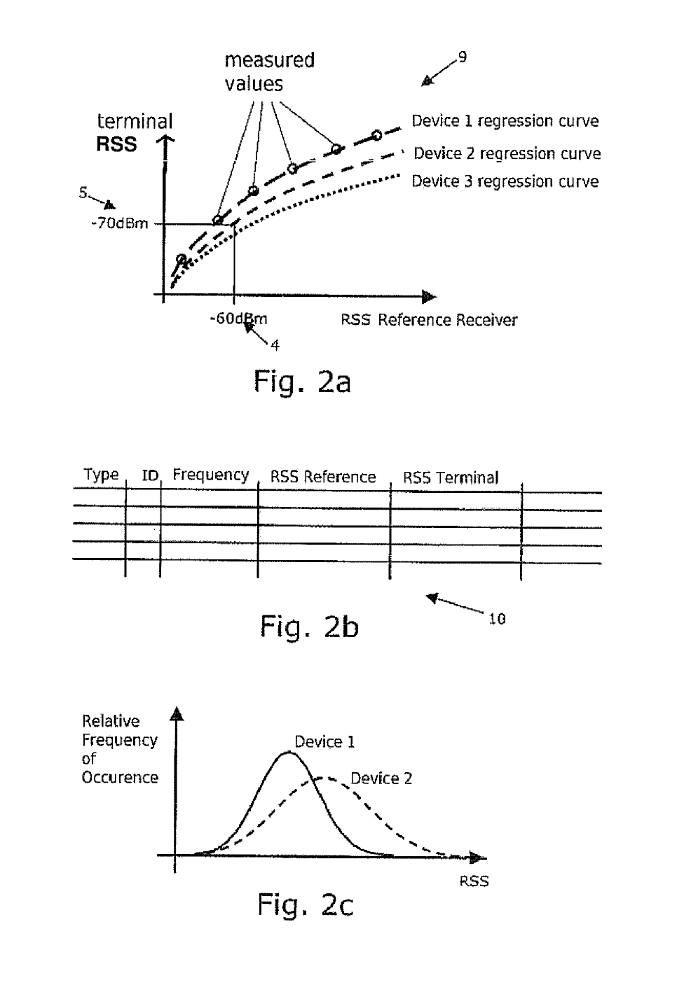

FIG. 2a shows a schematic representation of typical embodiments of regression curves generated according to the invention;

FIG. 2b shows an offset file generated according to the invention;

FIG. 2c shows measuring characteristics generated according to the invention of different communication devices;

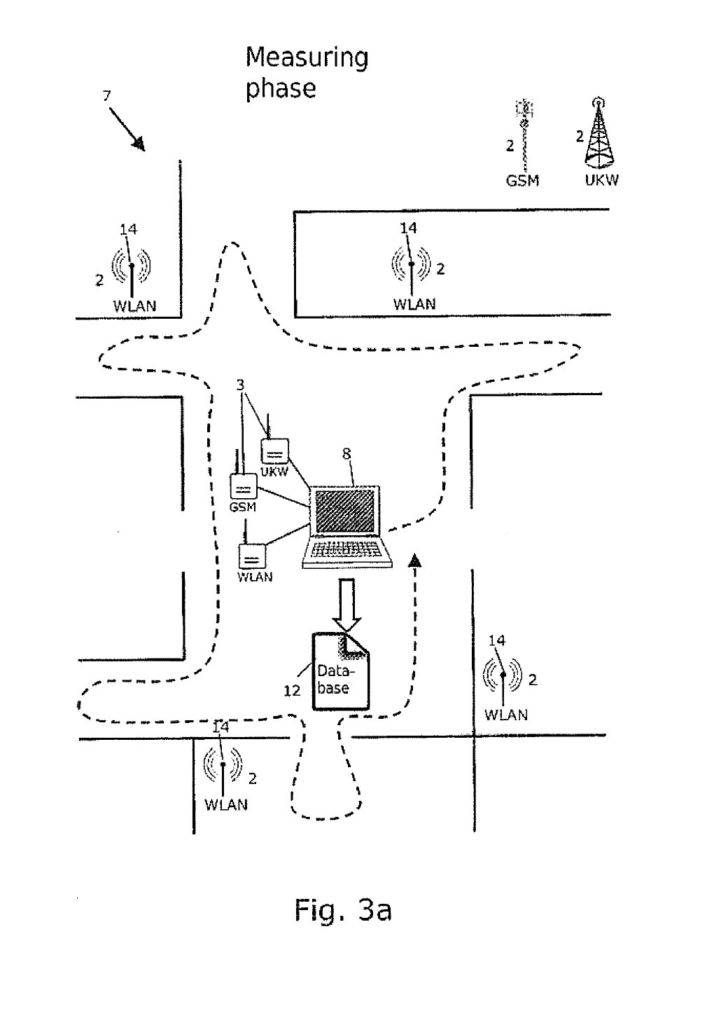

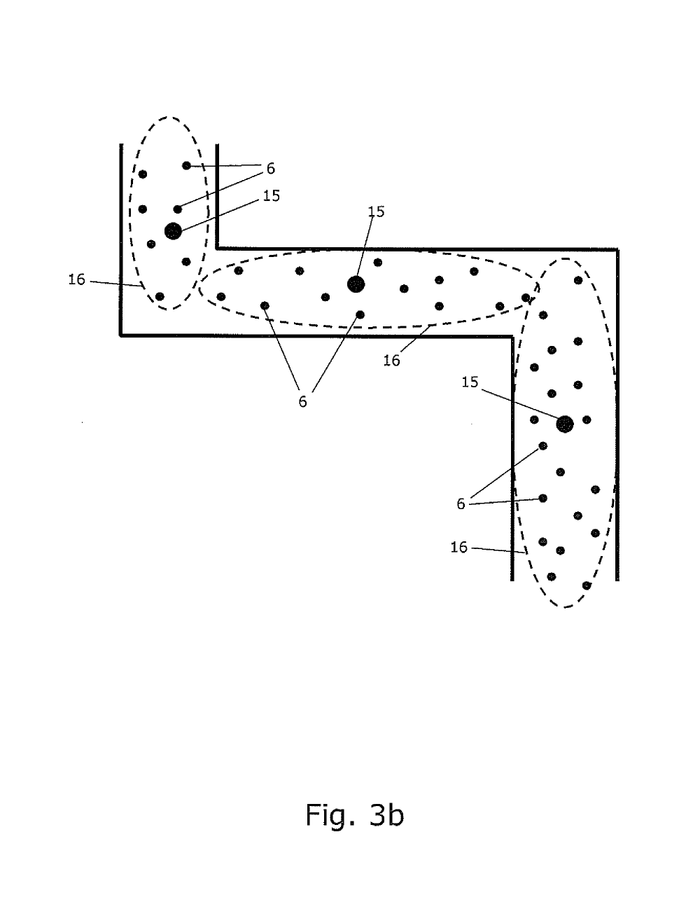

FIG. 3a shows a schematic representation of a typical embodiment of the measuring phase according to the invention;

FIG. 3b shows a schematic representation of a clustering of fingerprints according to the invention;

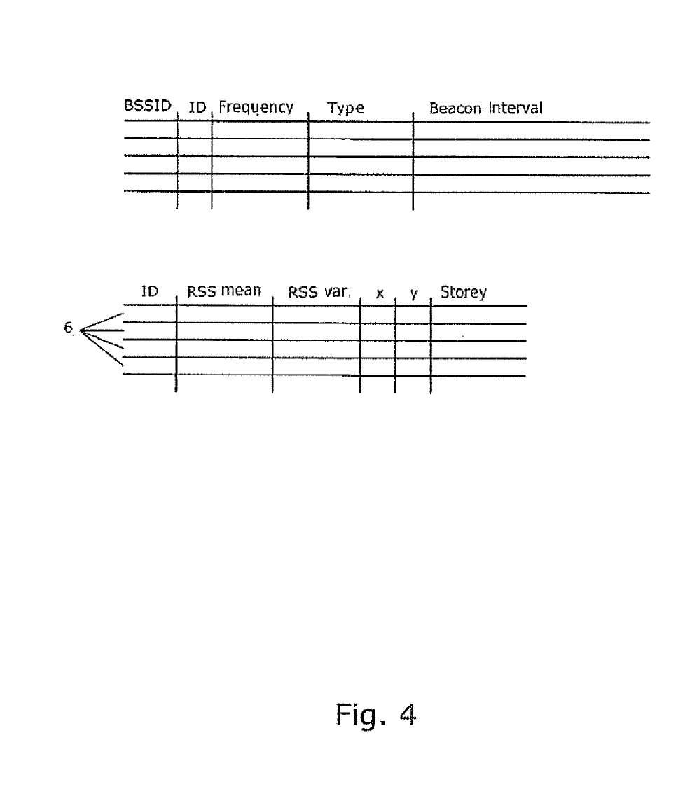

FIG. 4 shows a schematic representation of a typical embodiment of the database generated according to the invention;

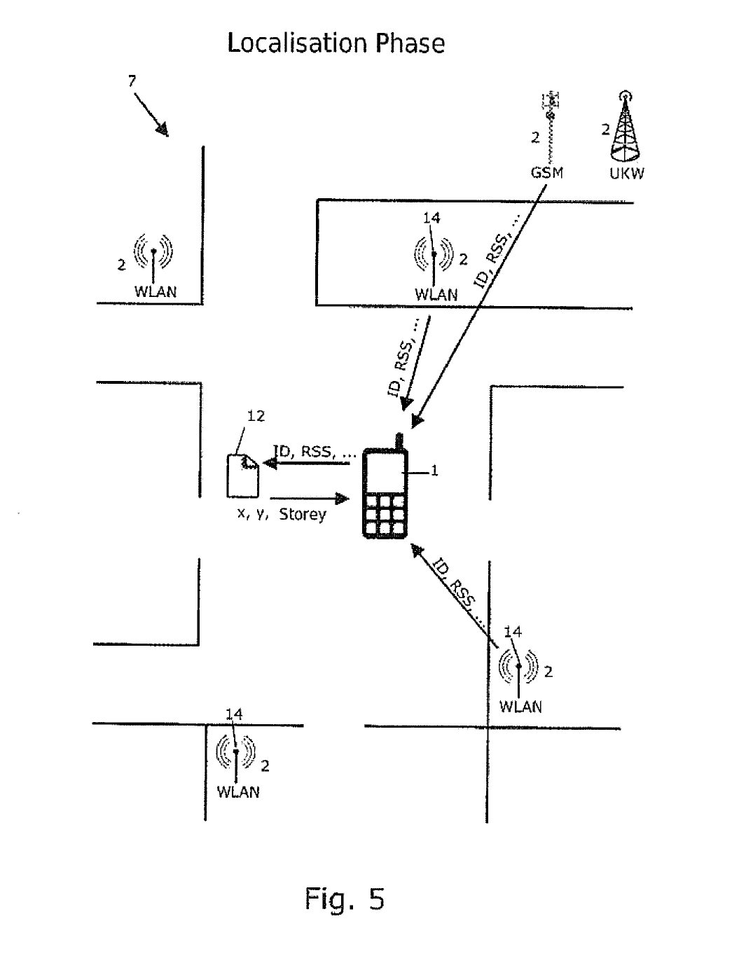

FIG. 5 shows a schematic representation of a typical embodiment of the localisation phase according to the invention;

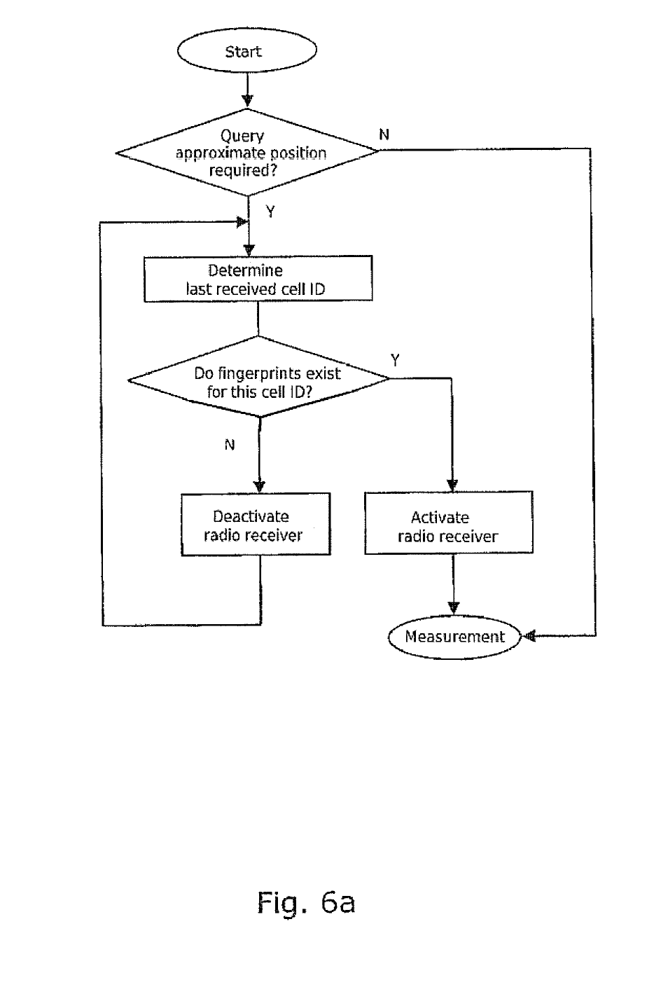

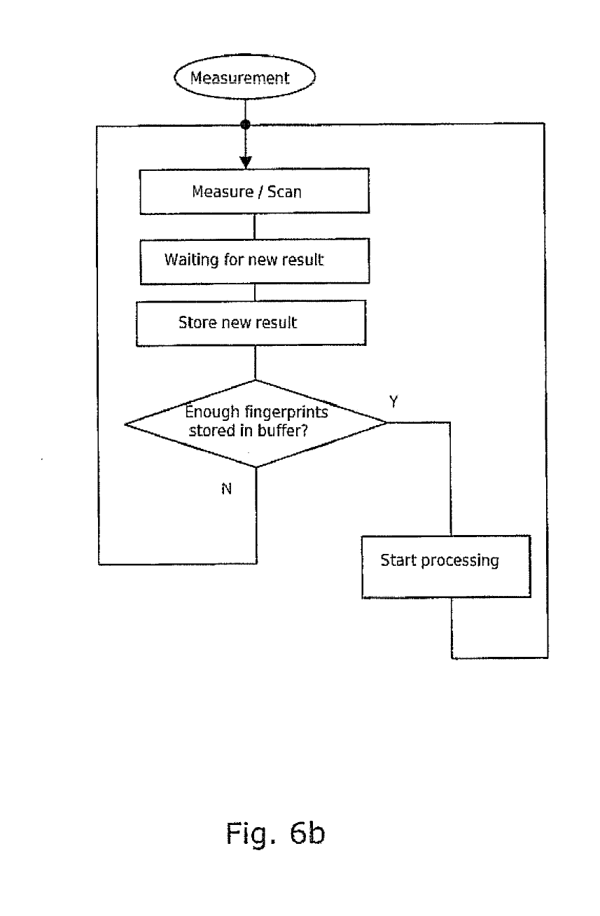

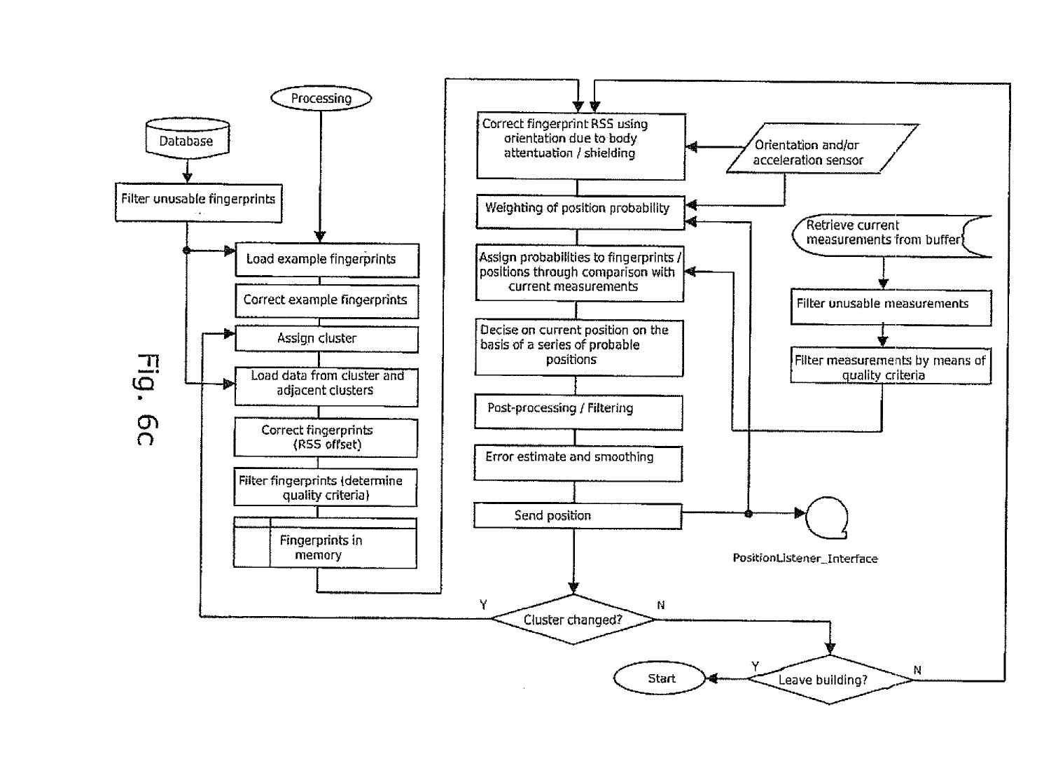

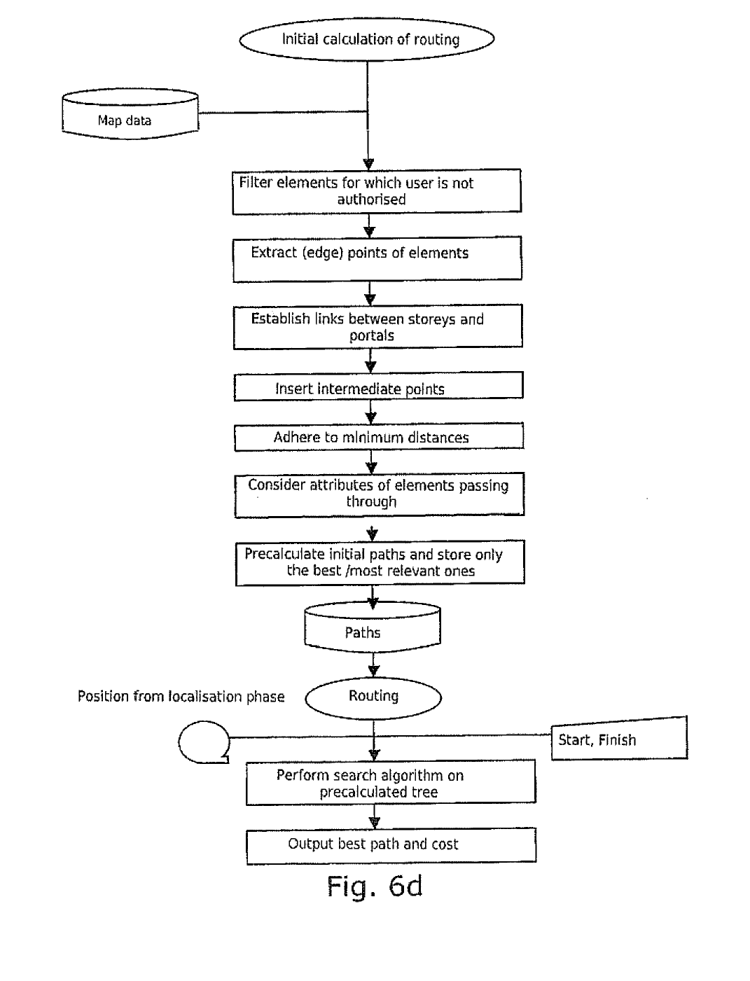

FIG. 6a-6d show schematic flow diagrams of typical embodiments of the method according to the invention.

FIG. 1 shows a schematic representation of a typical embodiment of the calibration phase according to the invention by way of a map 7. During the calibration phase the reference receivers 3 and the communication devices (terminals) 1 to be calibrated are connected with a data processing unit (computer) 8. Calibration is carried out on different radio networks 2, in particular VHF/FM radio, IEE 802.11 (WLAN) and mobile communication receivers (GSM/CDMA/UMTS or 4G). Using several types of receivers increases covering, redundancy, speed and accuracy. Moreover more devices can be supported. The radio networks 2 comprise, in particular, WLAN radio networks broadcast from access points 14.

The reference receivers 3 and the terminals 1 to be calibrated are connected with computer 8. The devices connect to the computer via a TCP/IP connection. Alternatively the computer initiates the connection via USB. The devices also transfer their own data such as “manufacturer”, product-ID” and “software version”.

Reference receivers 3 and communication devices 1 simultaneously measure radio networks 2 in the vicinity and at the same position as well as the following attributes thereof: frequency/channel, unequivocal identifier (BSSID3 for WLAN or BTS cell ID for GSM), receiving strength (RSS4).

Subsequently the values are transferred from the respective device to the computer 8, and an equation is calculated for converting terminal field strength into reference field strength with the aid of (linear) regression. Thereafter the location is changed and measured again until sufficient sample values are available in each possible range of input values in order to obtain a good regression. These are then stored in a global offset file 10 for each known device.

FIG. 2a shows a schematic representation of typical embodiments of regression curves 9 generated according to the invention.

The reference receiver for GSM may be a mobile phone and that for WLAN may consist of three 802.11 WLAN devices connected via USB. The three devices hop over the available WLAN channels (for example 14 channels in the 2.4 GHz band). Channel hopping averages the slightly different receiving strengths of the WLAN cards. If a particularly fast measuring rate is required, in particular during the measuring phase, several receivers may be used simultaneously (without hopping). Battery-powered USB hubs may be used as efficient and low-cost variants, although provision is nevertheless made for the use of battery-powered special hardware which allows all channels to be simultaneously recorded and 802.11 frames to be decoded.

FIG. 2b shows an embodiment according to the invention of the offset-file generated. For each communication device, type, ID, frequency and the measured RSS of the reference receiver and the measured RSS of the terminal are recorded. In addition numerous further parameters characterising the communication device or the receiver used, may be stored.

One of these additionally storable meta data is, in particular, the measuring characteristic shown in FIG. 2c (relative frequency of occurrence of received signal values for a given reference signal value distribution), which is different for each device. For example a first device may measure more often a somewhat higher value for a given RSS, and another device may measure more often a somewhat lower value. From the knowledge of this characteristic confidence intervals for the positions determined are calculated in the localisation phase.

FIG. 3a shows a schematic representation of a typical embodiment of the measuring phase according to the invention. During the measuring phase a map 7 of the area is imported. This includes recording the scale of the map. For example: x times y metres or alternatively 1 pixel corresponds to x millimetres. Several levels of detail and maps with varying resolutions may be imported. Normally three different detail levels or map sizes are used. Photographed escape routes and info graphics are also suitable sources. This process is repeated for each storey.

The measuring phase may be carried out on the communication device 1 or on the computer 8. Speeds of 200-1000 ms/point for WLAN can be achieved with a computer, and typically 10,000 ms/point with a communication devices. A longer measuring period increases accuracy. During “measuring” the RSS, ID and frequency values of the respective networks are stored together with the locations.

FIG. 3b shows a schematic layout of a measured area with numerous fingerprints 6. The fingerprints 6 are gathered iteratively to form associated clusters 16 using predefined criteria. At least one example fingerprint 15 is determined for each cluster 16. During the later localisation phase the radio network measured is compared, not with all fingerprints 6, but with only relevant example fingerprints 15. In this way a substantial increase in speed is achieved, since the comparison needs to be carried out, not with thousands, but only with some 10 to some 100 example fingerprints.

FIG. 4 shows a schematic representation of a typical embodiment of the database 12 generated according to the invention. The database comprises, for example, two schematically shown tables which on the one hand characterise the radio networks received (upper table) and on the other, specify the measured fingerprints for each radio network. These vales are stored, for example, every 5 metres for each point in each recorded storey. For the coordinate system an origin in the upper left building corner and the millimetre unit has proven useful. In addition to the RSS mean values and variances, individual RSS measurements may be optionally stored.

Excessively weak signals, excessively fluctuating signals and signals of mobile terminals are automatically discarded. In addition the system stores the computer or the device used for determining the values. It is possible to begin by defining paths which are then walked or travelled during the taking of measurements. During measuring these tasks are completed step by step.

if a map does not exist a map may be generated by selecting the room shape(s). If distance measurements do not exist, these are measured from the corners of the room. The room-ID values and corner values are then stored in addition to or instead of the X, Y coordinates.

During the post-processing phase building data is distributed as a compressed archive (ZIP file) or via a HTTP server to the clients. A ZIP file comprises:
measured values from the offline measuring phase;
the offset file from the calibration phase;
map-image material;
meta data;
room description.

The map-image material is sorted by storey and level of detail and stored as a compressed image (PNG) in partial areas of maximum 256×256 pixels. This breakdown is necessary because the devices have a very small RAM and cannot hold the entire map in the memory.

Furthermore when data is downloaded via HTTP, it is possible to transfer only the parts that are required. Any parts, once they have been transferred or downloaded to the device via a ZIP file, are temporarily stored/buffered in the device. Meta data are generally understood to be building name, overall size, name of storey, GPS coordinates of the origin or reference cell IDs or the like.

Finally, based on the plan in the computer, a room description may be optionally added. This includes recording rooms, areas, walls, shops, lifts, escalators, obstacles, conveyor belts etc. This data is required because the offer made to the user shall include routing, target-finding, opening times and other additional info.

All these entities are modelled in just a few elements and stored in a XML file or a database. Room information is prepared by displaying the map-image material on the computer in the background and superimposing the room descriptions.

FIG. 5 shows a schematic representation of a typical embodiment of the localisation phase according to the invention. Localisation is started by trying to determine whether buildings with WLAN coverage are present in the environment. If this cannot be determined this function is waived. If WLAN is available Wifi is activated in case it had been inactive, and the corresponding database 12 is unpacked or downloaded from a server and the measurement is started.

Fingerprints from the measuring phase are read into the memory in a space-saving manner and adapted to suit the current antenna. Unusable fingerprints are removed.

An optional clustering step during which fingerprints are filtered according to physically attainable entries, reduces, as described above, the amount of computing in the mobile devices and at the same time limits the search area to the meaningful direct environment. Outliers are thereby implicitly removed.

FIGS. 6a to 6d show schematic flow diagrams of typical embodiments of the method according to the invention. FIG. 6a shows the initial method steps following activation of the system. These method steps are carried out in order to keep the energy consumption of the system at a low level—the method could also be carried out without these steps if energy consumption does not need to be taken into account, or on laptops without built-in mobile telephone. For this purpose the first query consists in establishing whether an approximate position needs to be queried. Then, using the last received cell ID (GSM, CDMA or another mobile communications network), it is determined as to whether fingerprints already exist for this area (which may cover a radius of several kilometres). If this is the case, the required database is downloaded from the server, the radio receiver is activated and measurements are started, otherwise the radio receiver is deactivated. This has the advantage of consuming less energy.

As shown in FIG. 6b, measurements are then started. The frequency range is scanned, the received data is stored and scanning is continued, until the data buffer is full. When sufficient data packets exist, processing starts. The number of data packets depends on the task at hand, for example approximately 20 data packets suffice for a data buffer size of 2 seconds and a data packet interval of 100 ms.

FIG. 6c shows the method of processing if sufficient data points have been recorded in the data buffer. Initially the database containing the fingerprints recorded during the measuring phase is cleared of unusable fingerprints by filtering. These may be, in particular, fingerprints which were recorded on another frequency or in another radio network. Then the example fingerprints existing for the current area are taken from this database. Depending on the size of the area these may be a few hundred up to a few thousand records. The example fingerprints are corrected with the aid of the offset table, in order to match the recorded signal strength with the communication device used. Then, by comparing the recorded signal strength with the example fingerprints, those clusters in which the communication device is probably situated are identified, and all fingerprints present in the database which are relevant to these clusters are then loaded. Again, these may be a few hundred up to a few thousand records. Another correction is performed using the offset table. The fingerprints are then filtered using predefined quality criteria, for example minimum signal strength, maximum variance, maximum age, minimum number of measurements. Finally the remaining corrected fingerprints are stored in the memory of the communication device.

Thereafter, if necessary, the signal strength is corrected due to a weakening of the signal caused by the human body. This is done using a built-in compass or a built-in gyroscope or an acceleration sensor. Thereafter a weighting of the position probabilities is performed, wherein varied factors are taken into account, such as the path travelled up to now, local conditions such as walls or doors, escalators or conveyor belts, as well as data from an acceleration sensor or a gyroscope or compass. Each fingerprint is compared with the measured signal strengths taken from the buffer, wherein these measurements also are filtered prior to the comparison. Bayesian position probabilities are assigned to each relevant fingerprint, and special algorithms are used to determine which position is the most probable. Then follows post-processing and filtering of improbable or impossible results (for example localisation results in a position in a non-accessible area). Finally an error estimate and smoothing is carried out using known statistical methods (e.g. Kalman filter), and the position is sent to an interface.

Measuring is repeated constantly, wherein on the one hand it is checked whether the current cluster has changed, and on the other, whether the building is left. If the cluster changes the fingerprints of the new cluster are determined and loaded into the memory, and the old fingerprints are discarded. This has the advantage that only a comparatively small number of records needs to be kept constantly available in the memory of the communication device. If the building is left, the method returns to the initial state, as shown in FIG. 6a.

Finally FIG. 6d shows the method for path finding (routing) which is also part of the method according to the invention. Initially the possible paths are calculated and stored in a first phase (preparation routing). For this purpose elements are initially filtered for which the user is not authorised (for example, only certain personnel is allowed to use a door or an area, etc.). Then edge points of the elements are extracted (corners, edges). Then a link is established between storeys and between portals, i.e. direct links between points. Intermediate points are inserted. Then it is ensured that minimum distances to objects are adhered to (resulting in a route being established which may not be optimal from a mathematical point of view, but is more natural for the user). Attributes of the objects to be passed through, such as speed factors (conveyor belts) are taken into account, wherein zones may overlap and attributes are inherited and/or overlap. Finally possible routes are computed and only the best or most relevant are stored.

Then, in a further phase (“path finding”) the position is determined from the localisation phase and a start and finish point is queried. Using the pre-calculated paths a search algorithm is executed which results in the best path within a short time. This is output together with the cost (time).

The invention comprises not only the embodiments shown, but also other devices according to the invention as per description, figures or patent claims. In particular the embodiments shown are not to be interpreted as limiting, and also features shown in different embodiments may be combined with each other.

### LIST OF REFERENCE SYMBOLS

1 Communication device

2 radio network

3 reference receiver

4 reference field strength

5 terminal field strength

6 fingerprint

7 map

8 data processing unit

9 regression curve

10 offset file

11 reception module

12 database

13 server

14 access point

15 example fingerprint

16 cluster

1. A method for localising a communication device (1), wherein an assignment is made of field strengths measured on the communication device (1) to a location by measuring field strengths of at least one radio network (2) at known locations, characterised in that the method comprises the following steps:
a) a calibration phase, in which for at least one radio network (2) for at least one communication device (1) and using a reference receiver (3), an assignment made of the reference field strength (4) received by the reference receiver (3) to the terminal field strength (5) received by the respective communication device (1) and possibly of other data, is recorded and stored;
b) a measuring phase in which for at least one radio network (2) a field strength is recorded at known locations within the reception area, and processed and stored as a fingerprint (6) preferably together with further data;
c) a post-processing phase, in which the data recorded in the calibration phase and the measuring phase are made available at least partially to the communication device preferably together with a map (7) and further meta data;
d) a localisation phase, in which the field strength of at least one radio network (2) is received at the communication device (1) and in which the location of the communication device (1) is at least approximately determined from the received terminal field strength (5) and/or the data recorded during the calibration phase and the measuring phase.

2. The method according to claim 1, characterised in that the radio network (2) may be a broadcasting network, in particular VHF radio, a data network such as IEEE 802.11 (WLAN), a mobile communications network such as GSM or UMTS or another radio network such as CB radio, DCF77 or DECT, wherein suitable reference receivers (3) may be provided for the reception of these radio networks.

3. The method according to claim 1, characterised in that in the calibration phase the reference receivers (3) and the communication devices (1) measure the field strengths of the receivable radio networks (2) simultaneously and at the same position, and record additional data such as frequency or channel or identifier of the radio network (BSSID for WLAN, BTS cell ID for GSM).

4. The method according to claim 1, characterised in that in the calibration phase the data recorded by the reference receivers (3) and the communication devices (1) is transmitted to a data processing unit (8), where the location or the reception situation is repeatedly changed, until sufficient measured values are available for generating a communication device-specific and radio network-specific regression curve (9) between the terminal field strengths (5) recorded by the respective communication devices (1) and the reference field strengths (4) recorded by the reference receivers (3).

5. The method according to claim 4, characterised in that in the calibration phase the communication device-specific and radio network-specific regression curves (9) are stored for at least one communication device and at least one radio network (2) in an offset file (10).

6. The method according to claim 1, characterised in that in the calibration phase several reference receivers (3) are used for at least one radio network (2).

7. The method according to claim 1, characterised in that in the calibration phase averaging of the received field strength is performed across two or more channels for radio networks (2) transmitting over several channels.

8. The method according to claim 1, characterised in that in the measuring phase, for radio networks (2) transmitting over several channels, all or some of these channels are simultaneously recorded using reference receivers (3) with several reception modules (11).

9. The method according to claim 1, characterised in that in the measuring phase the RSS, the ID and/or the frequency of the radio network (2), the mean value and/or the variance of the received reference field strength (4) and the locations, preferably location coordinates, are stored in computer-readable form, preferably in a CSV file, XML file or a database (12), optionally specifying the building storey.

10. The method according to claim 1, characterised in that in the measuring phase an existing representation of the geographic conditions is used, in particular a map (7).

11. The method according to claim 1, characterised in that in the measuring phase the reference field strength (4) is recorded at fixed local intervals, for example in form of a chessboard pattern, at certain anchor points or along a previously defined path.

12. The method according to claim 1, characterised in that in the measuring phase the reference field strength (4) is recorded using a reference receiver (3) or communication device (1) connected to a computer.

13. The method according to claim 1, characterised in that during the measuring phase the geographic conditions are recorded in the form of location IDs and/or coordinates of walls, doors, rooms, corners, and/or in the form of conditions influencing the position of conveying means such as conveyor belts, escalators or the like.

14. The method according to claim 1, characterised in that in the measuring phase a clustering of fingerprints (6) is performed, wherein a specified quality criterion is used and for each cluster at least one example fingerprint (15) identifying the cluster is recorded.

15. The method according to claim 1, characterised in that the data supplied in the post-processing phase comprise, among others, data from the calibration phase, preferably in the form of an offset file (10), data from the measuring phase, preferably in the form of a database (12), as well as optionally maps (7) and metadata such as building names, overall size of the area, storey names, room description, GPS coordinates of the origin and/or reference cell IDs.

16. The method according to claim 1, characterised in that in the localisation phase the position determined by approximation is shown, in particular superimposed on a geographic representation, preferably a map (7) of the area covered, which was sent to the communication device (1).

17. The method according to claim 1, characterised in that in the localisation phase a check is performed on the radio networks (2) which can be received, and then relevant fingerprints (6) from the measuring phase are made available to the communication device (1) and adapted to suit the currently used communication device or the currently used antenna.

18. The method according to claim 1, characterised in that in the localisation phase fingerprints (6) graded as relevant by way of quality criteria are made available to the communication device (1).

19. The method according to claim 1, characterised in that in the localisation phase a comparison is initially made with relevant example fingerprints (15) whereupon a determination of relevant clusters is made and in a next step a comparison with fingerprints (6) of the selected cluster is made.

20. The method according to claim 1, characterised in that in the localisation phase a probability estimate and/or a weighting of fingerprints (6) and/or localisations is performed.

21. The method according to claim 1, characterised in that in the localisation phase methods for path-finding are carried out with the aid of the determined locations of the communication device (1) and the input of a desired target destination.

22. The method according to claim 1, characterised in that in the measuring phase, the magnetic field strength, the ambient light intensity in connection with the time of day or other data, particularly physical measurements, are recorded and stored together with the fingerprints (6).

23. The method according to claim 22, characterised in that by querying an accelerometer of the communication device (1), the magnetic field strength is stored as three-dimensional vector.

24. The method according to claim 22, characterised in that in the localisation phase, the measured data is used to calibrate the radio receiver of the communication device (1).

25. An apparatus for localising a communication device (1) within the reception area of at least one radio network (2), wherein based on field strength measurements of the radio network (2) at known locations, an assignment is made of field strengths measured on the communication device (1) to the locations, characterised in that the apparatus is adapted to carry out a method according to one of claims 1 to 24.

26. The apparatus according to claim 25, characterised in that the communication device (1) may be a mobile phone, a smart phone, a notebook, a laptop, a tablet-PC or any other portable electronic communication device.

27. The device according to claim 25, characterised in that the assignment made of the reference field strength (4) received by the reference receiver (3) to the terminal field strength (5) received by the respective communication device (1) is stored in an offset file (10) on a server (13).

28. The device according to claim 25, characterised in that the recorded fingerprints (6) are preferably stored together with further data in a XML file or in a database (12) on a server (13).

29. A computer program product which implements a method according to claim 1 on a computer.

30. A data carrier with a computer program product according to claim 29.
